(19) United States
(12) Patent Application Publication
(10) Pub. No.: US 2024/0399501 A1
(43) Pub. Date: Dec. 5, 2024

(54) DEVICE FOR LASER DEPOSITION WELDING WITH COAXIAL DEPOSITION MATERIAL FEED AND WITH DISTANCE MEASURING DEVICE

(71) Applicant: Precitec GmbH & Co. KG, Gaggenau (DE)

(72) Inventor: Igor Shkarban, Rheinstetten (DE)

(21) Appl. No.: 18/667,694

(22) Filed: May 17, 2024

(30) Foreign Application Priority Data
Jun. 1, 2023 (DE) 10 2023 114 435.9

(51) Int. Cl. B23K 26/342; B23K 26/06; B33Y 30/00; B33Y 50/02

(52) U.S. Cl. CPC B23K 26/342; B23K 26/0643; B23K 26/0648; B33Y 30/00; B33Y 50/02

(57) ABSTRACT

A device for laser deposition welding includes: a laser machining head for radiating a laser beam; a distance measuring device for measuring a distance using a measuring beam; a scanning device for deflecting the measuring beam; a coupling device for coupling the beam path of the measuring beam into the beam path of the laser beam, said coupling device being arranged after the scanning device in the beam path of the measuring beam; a feed device for coaxially feeding a deposition material; and a first and second reflector arranged in a common beam path of the laser beam and the measuring beam on a common central axis. The first reflector is configured to reflect the laser beam and the measuring beam outwards onto the second reflector at an angle with the central axis, and wherein the second reflector is configured to reflect the laser beam toward a machining area.

### CROSS-REFERENCE TO RELATED APPLICATION

This application claims priority to German application DE 10 2023 114 435.9, filed Jun. 1, 2023, which is hereby incorporated by reference in its entirety.

### FIELD OF THE INVENTION

The present disclosure relates to a device for laser deposition welding, in which a deposition material is fed coaxially with the laser beam, including a distance measuring device.

### BACKGROUND OF THE INVENTION

Laser deposition welding is an additive manufacturing process wherein a deposition material is melted using laser radiation and bonded to at least one workpiece.

WO 2018/178387 A1 describes a device for additive manufacturing, comprising a laser device, a feed device for a feed material and an interferometer for measuring a distance to the workpiece using an optical measuring beam.

US 2022/0134440 A1 describes a device for laser additive manufacturing, comprising first reflective optics for receiving and reflecting the laser beam and second reflective optics for receiving laser light reflected by the first reflective optics. The second reflective optics directs a portion of the received laser light coaxially with a supplied wire or powder base material in a cylindrical configuration onto the base material.

### SUMMARY OF THE INVENTION

An object of the present invention is to provide a compact structure that makes it possible to move an optical measuring beam for distance measurement in and around the machining area in a direction-independent manner, wherein influences of shadowing, in particular on a measurement result, are minimized or eliminated. It is particularly desirable to move the optical measuring beam in advance, in the wake and/or in the machining area (for in-process observation).

It is also an object to provide a device for laser deposition welding with coaxial material feed for additive manufacturing processes and a distance measurement, which makes it possible to evenly approach the fed material with the laser beam (particularly in the focus position) and to melt it evenly, as well as a to perform distance measurements at a large number of measuring positions.

One or more of these objects are achieved by a device for laser deposition welding as disclosed herein. Preferred embodiments are also disclosed.

The present disclosure relates to a device for laser deposition welding comprising a feed device for coaxially feeding the deposition material, a distance measuring device for measuring a distance using a measuring beam and a scanning device for deflecting the measuring beam. The feed device may be configured to deliver the deposition material at a feed location coaxially to the central axis or coaxially to the laser beam and/or to feed it coaxially to the machining area from a/the feed location. A first reflector and a second reflector are arranged on a common central axis of the two reflectors in the common beam path of the laser beam and the measuring beam in order to guide the laser beam and/or the measuring beam around the feed device. In particular, the laser beam and the measuring beam may be radiated essentially without shadows despite the coaxial feed of the deposition material since they are deflected around the feed location via the first reflector and the second reflector. Even if the feed itself may cause shadow at one point, this shadow is very small due to the positioning in the collimated working beam and may be neglected. The coaxially dispensed deposition material thus represents an obstacle on the common central axis, which is bypassed by the beam path via the first reflector and the second reflector, so that the dispensed deposition material does not cause any shadowing of the laser beam or the measuring beam.

The invention is based on reflecting the laser beam from the second reflector arranged on the common central axis in the direction of the machining area in order to achieve steady melting of the deposition material, while the measuring beam may be moved by the scanning device in a direction-independent and substantially shadow-free manner in and/or around the machining area. A compact structure of the laser machining head is achieved by the first reflector and the second reflector as well as by the feed device for coaxial feeding of the deposition material. In particular, the supplied deposition material can be approached evenly with the laser beam in the focus position.

According to one aspect of the invention, a device for laser deposition welding comprises a laser machining head for radiating a laser beam; a distance measuring device for measuring a distance using a measuring beam; a scanning device for deflecting the measuring beam; a coupling device for coupling the beam path of the measuring beam into the beam path of the laser beam; a feed device for coaxially feeding a deposition material; and a first reflector and a second reflector, wherein the first reflector is configured to reflect the laser beam and the measuring beam outwardly onto the second reflector at an angle with the central axis, and wherein the second reflector is configured to reflect the laser beam toward a machining area. The first and second reflectors have a common central axis and/or are arranged on a common central axis and/or are arranged in a common beam path of the laser beam and the measuring beam. In other words, the first reflector and the second reflector have a common central axis, i.e. the first reflector and the second reflector are arranged in the common beam path so that they have a common central axis. The first and second reflectors may be arranged between the coupling device and the feed device or in front of the feed device in the beam propagation direction of the laser beam.

It is particularly advantageous that the scanning device for deflecting the measuring beam, in conjunction with the first reflector and the second reflector, makes it possible to measure the distance from a workpiece or a deposited layer thickness at at least one defined measuring position, even with changing machining directions or feed speeds of the laser machining head, for example in advance, in the wake, and/or in the machining area or at a machining position. In particular, measurements that are defined with respect to a machining direction and/or a machining trajectory (e.g. in advance) are made possible by targeted deflection of the measuring beam using the scanning device. In particular, it is possible to use an interferometric measurement method with a 2D scanner with a reflective machining head that deflects the laser beam.

According to a further aspect of the invention, a device for laser deposition welding comprises a laser machining head for radiating a laser beam; a feed device for coaxially feeding a deposition material; and a first reflector and a second reflector having a common central axis, wherein the first reflector is configured to reflect the laser beam outwardly onto the second reflector at an angle with the central axis, and wherein the second reflector is configured to reflect the laser beam towards the machining area. The first and second reflectors are arranged on the common central axis and/or coaxially. In other words, the first reflector and the second reflector are arranged in the beam path of the laser beam in such a way that they have a common central axis. The first and second reflectors may be arranged in front of the feed device in the beam propagation direction of the laser beam.

The device according to any of said aspects may include one or more of the following features:

The machining area may refer to an area that includes a machining position (i.e. the position to which the laser beam is radiated) and/or a vicinity thereof. In particular, the machining area may refer to an area including the machining position, a position or an area in advance (i.e. a position to be machined or a vicinity thereof), and/or a position or an area in the wake (i.e. a position that has already been machined or a vicinity thereof).

The arrangement of the first and second reflectors may be configured for an almost rotationally symmetrical laser and/or measuring beam deflection.

The device may be a laser metal deposition device, also referred to as an LMD device or LMD system. The device may in particular be a device for laser deposition welding with a central coaxial feed of the deposition material. The device may be a device for laser deposition welding of a workpiece. The machining area may be a machining area on a workpiece. The device may in particular be an LMD system with coaxial material feed and rotationally symmetrical or almost rotationally symmetrical beam guidance, comprising a distance measuring device with a variable measuring position. The device may be configured to deposit material in a plurality of layers, each with a predetermined layer thickness, along a first direction or axis (so-called vertical direction or axis). The layer thicknesses may therefore be defined in a vertical direction or axis. The vertical direction or axis may be perpendicular to a workpiece surface.

The distance may be an elevation or a vertical distance or a layer thickness, for example with respect to a reference plane. For example, the distance may be a distance perpendicular to an (unmachined) workpiece surface. The distance measuring device may be configured to determine the elevation or the distance from an optical path length to a measuring position or to a position on a workpiece surface, in particular from an optical path length between a measuring position or a position on a workpiece surface and the distance measuring device.

The scanning device may be a 2D scanner and/or a galvo scanner including at least one, in particular two, reflective deflection elements, e.g. mirrors.

The device may further comprise a control device for performing open-loop and/or closed loop control of the device or components of the device, in particular for driving the scanning device and/or the feed device and/or a laser source.

The control device may be configured to deflect or move the measuring beam using the scanning device, for example on a predefined and/or freely selectable trajectory. In particular, the control device may be configured to drive the scanning device as a function of a feed speed or a change in the feed speed and/or as a function of a machining position or a change in the machining position in order to deflect or move the measuring beam. In particular, the control device may be configured to adapt a measuring position to path coordinates of a predetermined machining trajectory for the production of an end product. For example, the control device may perform open-loop and/or closed loop control of a measuring beam position and/or a measuring beam movement as a function of a feed movement of the device and/or as a function of a laser power and/or as a function of a material feed amount and/or as a function of a material feed rate.

The device may further comprise an evaluation device for evaluating data. The evaluation device may be part of a control and evaluation device of the device, which includes, for example, the above-mentioned control device. The distance measuring device may include an evaluation unit for determining the distance based on the measurement data. The evaluation unit may also be integrated in the evaluation device.

During laser deposition welding, a structure may be built from a deposition material. For example, the structure may be built on a workpiece, or the structure may form the workpiece. The structure may be built in layers along a machining trajectory. For example, a wall (wall-shaped structure) may be built by recurring or repeated deposition along a machining contour, each time offset in the height direction of the structure.

The device may be configured or suitable for laser deposition welding along a machining trajectory. The welding or deposition direction or machining direction then extends along the machining trajectory. The machining trajectory may also be referred to as the machining path. The terms machining direction or machining trajectory refer to the machining direction (in particular the welding direction) or the machining trajectory of the laser beam relative to the workpiece. The machining trajectory may in particular define a machining direction. The machining trajectory may include a corner or curve. The machining trajectory may be defined by a geometry of the workpiece or by a geometry of an end product to be formed in a respective layer or plane.

The device may be configured to position the machining area relative to the workpiece. The device may include a positioning device for positioning the machining area relative to the workpiece. The positioning device may, for example, include a robot arm or a gantry and/or an axis system for positioning or moving the laser machining head and/or the workpiece. The positioning device may be configured to position and/or move and/or orient the laser machining head and the workpiece relative to one another. The positioning device may be configured to move and/or orient the workpiece relative to the device or to the laser machining head. The positioning device may be configured to move and/or orient the device or the laser machining head with the distance measuring device, scanning device, coupling device, first reflector and second reflector arranged and/or carried thereon relative to the workpiece. The positioning device may comprise a robot arm or a gantry to which the laser machining head is attached. The positioning device may comprise an axis system for positioning the workpiece. The positioning device may be configured to move the laser beam along the machining trajectory.

The laser machining head may in particular comprise a housing through which the beam path of the laser beam is guided. The laser beam may also be referred to as a machining laser beam. The laser machining head may be configured to radiate a laser beam emerging from a laser beam source or an end of a laser guide fiber. The laser machining head may be configured to radiate the laser beam onto a workpiece. Beam guidance optics may be integrated into the laser machining head.

The distance measuring device may be a time-of-flight sensor. The measuring beam is an optical measuring beam. The distance measuring device may be an interferometric distance measuring device, for example an optical coherence tomography (“OCT” for short) distance measuring device. The interferometric distance measuring device may comprise a light source for the measuring beam, a detector for the measuring beam superimposed with light from a reference arm and/or the reference arm. In other words, measuring the distance may be based on optical coherence tomography. This type of distance measurement is based on the principle of using the coherence of light that has traveled an optical path length using an interferometer. For this purpose, the optical measuring beam is irradiated onto the machining area or onto the workpiece. A part of the optical measuring beam is radiated into a reference arm of the distance measuring device. The portion of the optical measuring beam reflected back from the machining area or the workpiece is superimposed and caused to interfere with light from the reference arm. By evaluating the superimposed light, information about the difference in the optical path length of the measuring arm and reference arm can be obtained. Information about the distance to the workpiece or about the surface profile of the workpiece can thus be obtained. The distance to the workpiece corresponds to an elevation of the workpiece at the relevant measuring position, e.g. with respect to a reference plane. Thus, by evaluating the superimposed light, information about an already existing elevation of the workpiece or about the surface profile of the workpiece can be obtained, for example information about an already existing elevation of the workpiece at a position at which deposition material is to be deposited and/or at which deposition material has already been deposited. Preferably the distance measuring device is a frequency domain OCT distance measuring device. This allows for a distance to be measured based on spectral components of the superimposed light. The reference arm may therefore have a constant length (optical path length). The distance measuring device may be stationary relative to the laser machining head. In other words, the scanning device may be configured to deflect the measuring beam relative to the laser beam.

The distance measuring device may be configured to obtain a distance measurement value based on a portion of the measuring beam reflected in the machining area and/or from the workpiece. The distance measuring device may be configured: to obtain at least one distance measurement value of a distance between the laser machining head radiating the laser beam and the workpiece, in particular a distance to a measuring position on the workpiece (i.e. the distance to the workpiece at the measuring position) and/or to obtain at least one distance measurement value along a scan figure of the measuring position or the measuring beam based on a portion of the measuring beam reflected in the machining area and/or from the workpiece and/or to obtain surface profile data of a surface of the workpiece, in particular surface profile data along a scan figure of the measuring position or the measuring beam. The distance may be determined from the at least one distance measurement value. The scan figure may also be referred to as a scan pattern, scanning figure, scanning path or trajectory of the measuring position on the workpiece. The measuring position or the measuring positions or the scan figure may be determined relative to a machining position and with respect to a machining direction and/or a machining trajectory.

The scanning device may be a scanner optics or scanning optics. The scanning device may be configured to deflect the measuring beam over or in a scanning area, for example on the workpiece. The scanning device may comprise at least one movable deflection element for the measuring beam, in particular at least one movable mirror (scanning mirror). The deflection element or the scanning mirror may be rotatable about at least one axis. The scanning device may comprise a movable mirror or two movable mirrors (scanning mirrors) for deflecting the measuring beam. The first movable mirror may be rotatable about a first axis of rotation and the second movable mirror may be rotatable about a second axis of rotation, the first axis of rotation and the second axis of rotation being at an angle, for example at an angle between 45° and 135°, in particular of approximately 75° or 90°, to each other. Alternatively, the scanning device may comprise a movable mirror rotatable or pivotable about at least two axes. In order to move the mirror or the first and second mirrors, the scanning device may accordingly comprise at least one galvanometer drive. Accordingly, the mirror or the first and second mirrors may be configured as galvanometer mirrors, or galvo mirrors for short. Accordingly, the scanning device may be configured as a galvanometer or galvo scanner, in particular as an XY galvo scanning system. The scanning device may alternatively have MEMS-based, piezoelectric and/or inductive drives. The scanning device may also be configured as a prism scanner or lens scanner. The scanning mirror may also be called a scanning mirror.

The scanning device may be arranged between the distance measuring device and the arrangement of the first and second reflectors, in particular between the distance measuring device and the coupling device. The coupling device may be arranged in the beam path of the measuring beam after the scanning device, i.e. the scanning device may be arranged between the distance measuring device and the coupling device. In the case of an interferometric distance measuring device, the scanning device may be arranged in a measuring arm. The scanning device may be arranged in the beam path of the measuring beam between a light source for the measuring beam and the coupling device. The scanning device may be a 2D scanning device. The scanning device may be configured to deflect the measuring beam in a first direction and to deflect it in a second direction transversely to the first direction. The first and second directions may be orthogonal to each other. The scanning device may be configured to deflect the measuring beam from a zero position. The zero position may denote an undeflected orientation of the measuring beam, in which the measuring beam extends coaxially to an optical axis of the beam path of the laser beam.

The scanning device may be configured to deflect the measuring beam independently of the laser beam. The scanning device allows for the measuring beam to be deflected and the measuring beam to be radiated onto the machining area or the workpiece at a measuring position or along a scan figure. The scanning device may in particular be configured to deflect the measuring beam in the beam path of the measuring beam to the machining area before coupling the measuring beam into the beam path of the laser beam. Thus, the measuring beam can be positioned on the workpiece relative to the machining position and can in particular be freely positioned on the workpiece within a scanning area of the scanning device. The scanning area may also be referred to as the deflection area or scanning area.

The scanning device may be configured to return light of the measuring beam coupled out from the coupling device and reflected from the machining area or from the workpiece to the distance measuring device. In particular, (at any time or at a given working position or deflection position of the scanning device) the light path of the measuring beam through the scanning device may be the same in both directions, i.e. of the radiated measuring beam and the measuring beam returning to the distance measuring device.

The distance measuring device and the scanning device may together form a distance measuring device with a variable measuring position, in particular an OCT distance measuring device with a variable measuring position.

The distance measuring device and/or the scanning device may be configured to adjust the focus position of the measuring beam, preferably independently of the focus position of the laser beam. In particular, the distance measuring device and/or the scanning device may be configured to focus the measuring beam onto the workpiece, in particular onto a surface of the workpiece.

The scanning device may be configured to adjust and/or modify a propagation direction and/or a propagation of the measuring beam. Such an adjustment of the propagation makes it possible to place the measuring beam on the first and second reflectors in such a way that it is directed from the correct direction and at the correct offset therefrom toward the interaction zone. In particular, the scanning device may be configured to adjust and/or modify an offset of the measuring beam with respect to the optical axis of the scanning device, an inclination of the measuring beam with respect to the optical axis and/or a beam diameter of the measuring beam. For this purpose, the scanning device may comprise the at least one mirror and optionally further optical elements. The scanning device may, for example, include collimation optics (e.g. at least one collimation lens) for collimating the measuring beam and/or focusing optics. Offsetting and/or tilting the measuring beam with respect to the optical axis may make it possible to view certain positions around the focus point (i.e. to be able to carry out the distance measurement there). A greater degree of beam propagation and a clear assignment of the measuring beam position and/or measuring beam movement to the feed direction and/or feed speed (machining direction and/or machining speed) may contribute to the unambiguity of the measurement result of the distance measurement. The scanning device and/or the control device for controlling the scanning device may be configured to place the measuring beam on the first and/or second reflector at positions with a unique reflection direction, respectively. This may prevent interference peaks that could result in an ambiguous measurement. In particular, the scanning device and/or a control device for controlling the scanning device may be configured to exclude a central point of the first reflector (e.g. a reflector tip) as the position of the measuring beam.

The coupling device is arranged after the scanning device in the beam path of the measuring beam. That is, the coupling device is arranged after the scanning device in the direction of the machining area in the beam path of the measuring beam. In other words, the scanning device is arranged between the distance measuring device and the coupling device. The coupling device is thus configured to couple the measuring beam (e.g. emitted by a light source of the measuring beam) after passing the scanning device in the direction of the machining area into the beam path of the laser beam. Coupling the beam path of the measuring beam into the beam path of the laser beam may comprise coupling the measuring beam in the direction of the workpiece into the beam path of the laser beam and/or coupling out light of the measuring beam reflected (from the workpiece) from the beam path of the laser beam traveling in the reverse direction. The coupling device may comprise a beam splitter, for example a dichroic mirror. The coupling device may be referred to as a coupler or beam coupler. The coupling device may be configured to couple the beam path of the measuring beam (or an optical axis thereof) in parallel to the optical axis of the beam path of the laser beam. The measuring beam or the optical axis thereof may thus be guided in parallel to the laser beam, in particular via the first reflector and/or the second reflector.

The feed device is configured to feed the deposition material coaxially, i.e. coaxially to the central axis (common central axis of the first reflector and the second reflector) or coaxially to the beam path of the laser beam (in front of the reflectors). The feed device may be configured to feed the deposition material coaxially and/or centrally, i.e. centrally with respect to the central axis or to the beam path of the laser beam. The feed device may be configured to deliver the deposition material at a feed location coaxially to the central axis (common central axis of the first reflector and the second reflector) or coaxially to the beam path of the laser beam (i.e. in a direction coaxial to the central axis or to the beam path of the laser beam). The feed device may be configured to feed the deposition material from the feed location to the machining area coaxially with the central axis. The feed device may have a delivery opening for the deposition material at the feed location.

The machining area may be located on the central axis of the first and second reflectors in the beam path of the laser beam behind the first reflector and/or behind the feed location.

The first reflector and the second reflector are arranged such as to have a common central axis. The arrangement of the first and second reflectors may be arranged between the coupling device and the feed device. The common beam path of the laser beam and the measuring beam may be defined or extend between the coupling device and the feed device.

Due to the first and second reflectors being arranged on a common central axis, a compact structure for beam shaping of the laser beam can be achieved, wherein the deposition material can be approached with the laser beam from several sides, in particular in a ring shape. The first reflector and the second reflector each represent an optical deflection element. The first reflector may be configured to reflect the laser beam outwards (outwards, i.e. in relation to the central axis or the axis of the beam path of the laser beam). The first reflector prevents the measuring beam from radiating onto the machining area or the workpiece along or in parallel to the optical axis of the laser beam. The common central axis of the first reflector and the second reflector may be coaxial with the beam path of the laser beam or with the axis of the laser beam incident on the first reflector. The first reflector may be configured to reflect the laser beam outwards from a path along the optical axis and/or in parallel to the optical axis. The first reflector may be configured to reflect the laser beam and the measuring beam outwards onto the second reflector at an inclination with respect to the central axis.

The second reflector may be arranged concentrically with respect to the first reflector. In other words, the central axis of the first reflector and the central axis of the second reflector are coaxial and are referred to as the common central axis. The second reflector may be configured to reflect the laser beam toward the machining area rotationally symmetrically or concentrically with respect to the central axis or to the optical axis of the laser beam, for example in a cylindrical or cylindrical barrel-shaped beam configuration or a conically converging or cone shell-shaped beam configuration. The second reflector may be configured to reflect the laser beam from a plurality of circumferential directions concentrically toward the machining area or concentrically toward the deposition material fed and/or dispensed by the feed device.

The first reflector is configured to reflect the laser beam and the measuring beam outwards onto the second reflector at an angle with the central axis. Here, “central axis” may in particular refer to the central axis of the first reflector and/or the second reflector. The central axis may extend coaxially with the beam path of the laser beam, in particular with the beam path of the laser beam in the direction of beam propagation in front of the first and/or second reflector. The angle with respect to the central axis may, for example, be greater than 90°, so that a reflection occurs outwards in the backward direction. The second reflector may be arranged above the first reflector and/or at the same elevation as the first reflector with respect to the beam path of the laser beam to the machining area. This allows for a particularly compact structure. The first reflector may accordingly be configured to reflect the laser beam and the measuring beam in the opposite direction to the direction of incidence.

The second reflector may be configured to reflect the laser beam toward the machining area in an offset manner in parallel to the central axis or at an angle with the central axis. The second reflector may be configured to reflect the laser beam concentrically and/or from several sides toward the machining area. As a result, the fed deposition material can be approached particularly evenly with the laser beam in the focus position. By evenly approaching the deposition material with the laser beam, particularly in the focus position of the laser beam, particularly steady melting of the deposition material can be achieved.

The arrangement of the first and second reflectors may be configured to deflect the laser beam rotationally symmetrically to the axis of the laser beam incident on the first reflector. The deflected laser beam may have an annular cross section, i.e. a cross section at the center of which the laser beam has an intensity of approximately zero. The deflected measuring beam may have a circular or ellipsoidal cross-section, i.e. a circular or ellipsoidal cross-section at the center of which the measuring beam has an intensity maximum and/or within which the measuring beam consistently has an intensity greater than zero. The first reflector and/or the second reflector may have at least one reflective surface, in particular at least one reflective metallic surface. Together, the first reflector and the second reflector may form a beam shaping optics configured to generate an annular beam profile (or an annular beam configuration) of the laser beam. For example, the feed location of the deposition material and/or the dispensing opening for the deposition material may be surrounded by the annular beam profile of the laser beam. The beam profile of the laser beam may, for example, be cylindrical and/or conically converging after the second reflector.

The laser beam and the measuring beam may extend in parallel in the common beam path. At least in the zero position of the measuring beam, the laser beam and the measuring beam may extend in parallel and/or coaxially in the common beam path. In particular, the coupling device may be configured to couple the measuring beam into the beam path of the laser beam in parallel and/or coaxial to the laser beam.

The machining area may also be referred to as the interaction zone. An interaction between the workpiece, the deposition material and the laser beam may take place in the machining area. The deposition material may be applied to the workpiece, with the deposition material being welded to the workpiece. The energy of the laser beam may melt the deposition material and/or material of the workpiece. The first and second reflectors may be configured to approach the fed deposition material evenly with the laser beam to in the focus position.

The laser machining head may be configured to radiate a laser beam emerging from a laser (light) source or an end of a laser guide fiber onto the machining area or the workpiece. The laser machining head may be configured to supply the laser beam to the coupling device or the first reflector with a circular or ellipsoidal beam cross section and/or a (transversal) beam profile in which a main intensity region includes the optical axis (of the laser beam). For example, there may be a maximum or a plateau in the beam intensity on the optical axis. For example, the laser machining head may be configured to emit the laser beam with a Gaussian beam profile

The device may further comprise a collimation device for collimating the laser beam. The collimation device for the laser beam may be arranged in front of the coupling device in the beam propagation direction of the laser beam. The collimation device for the laser beam or a part thereof may be adjustable along an optical axis of the collimation device and/or along a beam propagation direction of the laser beam in order to adjust a focus position of the laser beam.

The device may further comprise a laser source for generating the laser beam or may be configured to couple the laser beam from a laser source for generating the laser beam into the laser machining head, for example by means of a fiber coupler. The laser source may also be referred to as a laser for short. The laser may be configured as a single-mode laser, as a multi-mode laser, as a solid-state laser and/or as a fiber laser. The device may comprise an optical fiber for guiding the laser beam from the laser source to the laser machining head. The device may further comprise an interface for transmitting data to an external system.

The device for laser deposition welding may be configured to focus the laser beam into the machining area, for example to focus it into a focus plane, e.g. into a focus point or into an annular focus. Accordingly, the device may include focusing optics for focusing the laser beam and/or the measuring beam. The focusing optics may be or include a lens, a focusing lens, a converging lens, a lens group, a telecentric lens, or an f-theta lens, in particular a telecentric f-theta lens. The f-theta lens is preferably configured for the wavelengths of both the measuring beam and the laser beam. The focusing optics may be arranged after the second reflector in the beam path of the laser beam. The focusing optics may include two or more lenses, the distances of which can at least be partially changed from one another in order to adjust or change the focus position.

The focusing optics may be arranged on the common central axis in order to focus the laser beam and/or the measuring beam. The second reflector may be configured to reflect the laser beam and/or the measuring beam onto the machining area through the focusing optics at an angle with the central axis. Accordingly, the focusing optics may be configured to direct the laser beam reflected from the second reflector onto the focusing optics at an angle with the central axis onto the machining area. The focusing optics may in particular include or be a focusing lens. For example, the second reflector may be configured to reflect the laser beam as a parallel beam.

The second reflector may be configured to direct the laser beam onto the machining area directly or via at least one further optical element at an angle with the central axis. The at least one further optical element may be the focusing optics.

The second reflector may be configured to focus the laser beam and/or the measuring beam, in particular to focus it with respect to a machining point and/or to focus it into the machining area. The second reflector may be, for example, a (parabolic) focusing mirror. The second reflector may, for example, be a ring segment of a parabolic mirror or have reflective surfaces in the form of segments of a paraboloid of revolution.

The control device for controlling the scanning device may be configured to control the scanning device for positioning or moving the measuring beam based on a machining direction and/or a machining trajectory (in particular based on a machining direction and/or a machining trajectory of the device or the laser machining head). A measurement position and/or a scan figure may thus be adjusted and/or oriented based on a machining direction and/or a machining trajectory. The control device may be configured to control the scanning device for positioning or moving the measuring beam along the machining trajectory with or without superimposition of a scan figure or an oscillating movement. The measuring beam may therefore be positioned in advance or in the wake, for example adapted to the current machining direction or to the machining trajectory. For example, if machining is carried out in the X direction, the measuring beam may be positioned in the X direction in advance or in the wake; then, if the machining direction changes and now is carried out in the Y direction, by controlling the scanning device, the measuring beam can be positioned immediately in the Y direction in advance or in the wake. In particular, the control device may be configured to control the scanning device for positioning or moving the measuring beam based on a machining direction and/or machining trajectory and a current machining position. The control device may, for example, be configured to position the measuring beam on the machining trajectory with an offset corresponding to a predetermined time offset (in particular according to a machining speed along the machining trajectory) or with an offset corresponding to a predetermined path length along the machining trajectory, relative to the current machining position. The offset may be, for example, 0 mm to 10 mm, in particular 0 mm to 5 mm, 0 mm to 2 mm, or 2 mm to 5 mm.

The distance measuring device may be configured to measure a distance at a measuring position in advance, in the machining area (or at the machining point) and/or in the wake, in particular based on a machining direction and/or a machining trajectory. The control device may be configured to position (in particular move) the measuring beam based on a machining direction and/or a machining trajectory. The control device may be configured to position (in particular move) the measuring beam in advance, in the machining area (or at the machining point) and/or in the wake (with respect to the current machining position), in particular based on a machining direction and/or a machining trajectory. For example, a measurement of the distance in advance or in the wake may also be carried out on the machining trajectory if the machining trajectory includes a curve or corner between the measuring position and the current machining position. The respective positioning may be superimposed with a scan figure or an oscillating movement. The scan figure may include an oscillating movement. Controlling to move the measuring beam may comprise controlling to variably position the measuring beam. The measuring beam may be moved along or on a scan path. The scan path may in particular include a scan figure.

The control device may be configured to control the scanning device in order to move the measuring beam according to a predetermined scan figure or an oscillating movement. The scan figure may include an oscillating movement. The control device may be configured to position and/or orient the scan figure based on a machining direction and/or a machining trajectory (of the laser machining head). The control device may be configured to position the scan figure at an intended measuring position and/or to orient it at the measuring position based on a machining direction and/or a machining trajectory. The scan figure may accordingly be positioned on the machining trajectory, the positioning being carried out depending on a machining direction and/or in advance or in the wake of the machining position. The positioning is carried out with respect to the machining position. For example, the scan figure may be positioned at a position and with an orientation depending on the machining trajectory. The scan figure may be configured, for example, as a line or as an arc, in particular as a line or arc transversely or at an angle with the machining trajectory. The scan figure may intersect the machining trajectory, in particular at right angles.

The control device may be configured to control the scanning device in order to adjust and/or modify an offset of the measuring beam with respect to the machining position, an inclination of the measuring beam with respect to the optical axis of the device or the focusing optics, and/or a beam diameter of the measuring beam. The measuring beam may therefore, for example, be directed so as to be offset and/or oblique. The optical axis of the scanning device is the optical axis of the beam path of the measuring beam on the side of the scanning device at which the measuring beam enters the scanning device from the distance measuring device. It may correspond to the optical axis of the beam path of the laser beam at the coupling device and/or correspond to the zero position of the deflection of the measuring beam. The measuring beam may deviate from the zero position at a point in time, in particular deviate on one side.

The device may include a memory for calibration data, in particular for calibration data taking into account an optical distortion and/or reference elevation data of a beam path of the measuring beam via the first reflector and/or the second reflector and/or the at least one optical element, in particular said or other calibration data as a function of the position of the measuring beam, the deflection of the measuring beam by the scanning device and/or the orientation of the beam deflection and/or the orientation of the coupling device and/or the orientation or arrangement of the scanning device. The calibration data may include reference elevation data and/or XY calibration data. In other words, calibration data from an XY calibration or a calibration of the XY plane or reference plane may ensure that positions on the workpiece are correctly mapped, i.e. measurement positions can be set correctly. In addition, this coordinate system may be supplemented with the reference elevation data (in the Z direction). The control device may be configured to control the scanning device for positioning or moving the measuring beam based on the calibration data stored in the memory. By correcting the optical distortion of the position on the working plane or workpiece surface, it can be ensured that measurements are taken at the correct location. To control the material feed, the correct elevation value, i.e. the measured value at the correct position in relation to a reference plane, is needed. The control device may be configured to control the scanning device for positioning or moving the measuring beam based on the calibration data stored in the memory, in particular on the data of the XY calibration, and/or based on the machining direction (welding direction) and/or a machining trajectory or scan figure. In particular, the relationship between the position of the measuring beam or the orientation of the beam deflection (scanner and other elements) may be brought into correlation with the welding direction, i.e. the position of the measuring beam or the orientation of the beam deflection by the scanning device may be controlled as a function of the machining direction. The reference elevation data may, for example, vary (i.e. include different values) depending on the deflection of the measuring beam by the scanning device, in particular depending on an offset and/or an orientation of the deflection of the measuring beam. That is, the reference elevation data may include or be optical path lengths to the respective measurement positions with respect to a reference plane, so that a change in path length due to the scan position or measurement position can be taken into account. The evaluation based on the reference elevation data therefore makes it possible to take into account a change in the optical path length of the measuring beam when the position of the measuring beam changes. When, for example, a change in the deflection of the measuring beam results in a different path of the measuring beam via the first and second reflectors, which has a different optical path length, a correspondingly adjusted distance measurement may be enabled by the reference elevation data. In particular, the measuring beam may therefore be positioned or moved according to a measuring position and/or a predetermined scan figure of the measuring beam at a measuring position, whereby an optical distortion and/or a varying optical path length of the beam path of the measuring beam can be compensated for. In particular, for each positioning or movement of the measuring beam described in the present disclosure, the control device may be configured to control the scanning device for positioning or moving the measuring beam also based on the calibration data stored in the memory.

The deposition material may be a deposition material in the form of a wire, a powder-filled wire or a powder. The deposition material may comprise at least one metal. The deposition material may also be referred to as feed material. The feeding device may include a wire guide. The deposition material may comprise an alloy and/or materials for forming an alloy, in particular materials for forming an alloy during laser deposition welding of the deposition material.

The laser machining head may be a deposition material application head, in particular a powder application head and/or wire application head. The laser machining head may include the feeding device. The laser machining head may include the first reflector and the second reflector.

The device may be used, for example, for the following applications: Laser deposition welding may comprise: layer application of deposition material, producing a homogeneous composition of workpieces, application of deposition material in the form of a powder-filled wire or a wire alloy, coating a turbine blade, producing a part (workpiece). For example, the workpiece may be or include a turbine blade, and the laser deposition welding may comprise: coating the turbine blade with the deposition material, for example for coating with an alloy. An alloy may be created, for example, by applying a coating material in the form of a powder-filled wire or a wire alloy. A powder-filled wire may, for example, comprise a first material as a wire and a second material as a powder filling of the wire, so that an alloy of the first material and the second material may be formed during laser deposition welding.

The first reflector may be substantially conical and/or pyramid-shaped, and/or the first reflector may have at least one reflecting surface with continuous or discrete rotational symmetry with respect to the common central axis. The first reflector may accordingly be configured to reflect the laser beam rotationally symmetrically with respect to the central axis. Here, rotationally symmetrical may include continuously rotationally symmetrical (i.e. rotationally symmetrical at every angle) or discretely rotationally symmetrical (i.e. planar surfaces for certain evenly distributed angular ranges, e.g. pyramids with equilateral bases). The discrete rotational symmetry may be at least threefold discrete rotational symmetry. The first reflector may be configured to deflect the laser beam rotationally symmetrically or substantially rotationally symmetrically or almost rotationally symmetrically. The first reflector may be configured to reflect the incident laser beam in an annular beam configuration (in an annular beam profile), in particular to reflect it in an annularly widening beam configuration. In other words, the laser beam has an annular beam configuration (an annular beam profile) after reflection from the first reflector. The first reflector may in particular be configured to generate an annular beam profile of the laser beam by reflecting the laser beam. The first reflector may have the shape of a cone or a regular pyramid. The annular beam configuration or the annular beam profile may be continuously rotationally symmetrical or may be discretely rotationally symmetrical. Accordingly, the annular beam configuration or the annular beam profile may be continuously annular may can be annular with a plurality of separate and/or spaced segments, in particular at least three segments. The first reflector may have a reflective conical surface. The beam profile may be segmentedly annular when, for example, the first reflector does not have the shape of a round cone, but rather the shape of a pyramidal cone (pyramid). The first reflector may be configured to distribute the laser beam evenly in directions radial to the central axis or to the optical axis of the beam path. The first reflector may be arranged in the middle of the second reflector.

The second reflector may have at least one reflecting surface with continuous or discrete rotational symmetry with respect to the common central axis. As a result, the fed deposition material can be approached particularly evenly with the laser beam in the focus position. The second reflector may be configured to reflect the laser beam reflected by the first reflector in an annular beam configuration (or with an annular beam profile). The second reflector may be configured to reflect the laser beam reflected by the first reflector rotationally symmetrically with respect to the central axis. Here, rotationally symmetrical may include continuously rotationally symmetrical (i.e. rotationally symmetrical at every angle) or discretely rotationally symmetrical (i.e. flat surfaces for certain evenly distributed angular ranges, e.g. pyramids with equilateral bases, or rotationally symmetrical for certain rotational angles, in particular divisors of) 360°. The discrete rotational symmetry may be at least threefold discrete rotational symmetry. The second reflector may be configured to deflect the laser beam rotationally symmetrically or substantially rotationally symmetrically or almost rotationally symmetrically. The annular beam configuration or the annular beam profile may be continuously annular or annular with a plurality of separate and/or spaced segments, in particular at least three segments.

The second reflector may be annular and/or have a circular recess which is concentric to the central axis an surrounds a reflective surface, and/or the second reflector may be a ring segment of a parabolic mirror. As a result, the fed deposition material can be approached particularly evenly with the laser beam in the focus position. The second reflector may have a reflecting surface in the form of an annular segment of a paraboloid of revolution. The second reflector may have reflective surfaces in the form of segments of a paraboloid of revolution. The second reflector may be arranged concentrically with respect to the first reflector and/or radially outside the first reflector. The second reflector may form a ring or have a plurality of separate segments or parts. The second reflector may be straight in a radial cross section (radial with respect to the central axis) or have a curvature, in particular a concave curvature.

The first reflector and/or the second reflector may be configured to deflect the laser beam rotationally symmetrically or substantially rotationally symmetrically or almost rotationally symmetrically. As a result, the fed deposition material can be approached particularly evenly with the laser beam in the focus position.

The first reflector and/or the second reflector may have a metallic surface. In particular, the first reflector and/or the second reflector may be made of metal.

The laser beam may be annular after exiting the laser machining head and/or the measuring beam may be circular after exiting the laser machining head or move on a circular scanning path. In particular, the laser beam may have an annular beam profile after exiting the laser machining head.

The device may comprise an evaluation device for determining a surface geometry from distances measured by the distance measuring device, for example elevation values. The surface geometry may in particular be a surface geometry along a scan figure or a scan path. In particular, a surface geometry of a previous material deposition may be determined. The surface geometry may comprise an elevation profile, in particular an elevation profile along the scan figure or the scan path, and/or an elevation or depth of a workpiece at a measuring position on a machining trajectory, and/or an elevation or depth of an applied deposition material at a measuring position on a machining trajectory. The evaluation device may be configured to determine the surface geometry in advance, in the machining area, and/or in the wake. For example, a distance measurement may be carried out in the melt, for example close to the central axis or the machining point. The surface geometry may be determined from a point measurement and/or from distance measurements along a scan figure or a scan path.

The evaluation device may be configured to determine an elevation based on a surface geometry. For example, an average value of a bead profile (elevation profile of a weld bead) may be determined as an elevation, or a maximum value of a bead profile may be determined as an elevation. The evaluation device may be configured to detect an deposition edge (of the previously applied deposition material). Based on the surface geometry in advance or in the wake, it can be recognized whether a previous material deposition was too high or too low. For example, a deposition edge may be monitored. A product to be created (the workpiece) may be monitored.

The device may comprise a deposition control device for performing open-loop and/or closed loop control of the feed of material through the feed device. The deposition control device may be integrated into the control device or into the control and evaluation device. The deposition control device may be configured to perform open-loop and/or closed loop control of the material feed or the material deposition as a function of a laser power of the laser beam and/or a distance measured by the distance measuring device and/or a specific surface geometry, in particular as a function of a distance measured by the distance measuring device and/or a surface geometry at a surface position or measuring position that corresponds to the current machining area, and/or in particular as a function of the distance measurement values measured by the distance measuring device at a measuring position in the advance, in the machining area and/or in the wake and/or based on the surface geometry determined by the evaluation device. The distance, the distance measurement values or the distances may in particular be a distance, distance measurement values or distances that were measured at a measurement position in the advance, in the machining area and/or in the wake, said measurement position corresponding to the current machining area or machining point. Closed-loop control is understood to mean control with feedback, e.g. when measuring distances in the machining area or in advance of a same machining pass or when measuring distances in the machining area or in the wake of a previous machining pass.

The deposition control device may be configured to perform open-loop and/or closed loop control of the material feed through the feed device depending on a surface geometry determined by the evaluation device. The deposition control device may, for example, be configured to compensate for any deviations of a surface geometry from a target elevation (i.e. a layer thickness to be deposited) on the machining trajectory. By measuring the existing elevation or depth in advance, the material feed at the current machining point can be close-loop controlled immediately, without or with a time delay. The deposition control device may in particular comprise a PI (proportional-integral) controller, in particular a PI controller with a time offset. During laser deposition welding, corner points or threshold points are especially susceptible to too much material deposition, or too little material deposition, or an elevation that is too high or an elevation that is too low. For example, any humps or other unevenness in a deposited material structure may be compensated for in a next machining pass at the appropriate point in the machining trajectory. The distance measurement may be carried out in advance of the current machining pass or in the wake of the previous machining pass. Errors such as deviations from a target elevation may thus be corrected, for example unevenness of a bead and/or deviations from a target elevation caused by capillary forces. When applying the deposition material layer by layer, a particularly high level of uniformity in the application elevation can be achieved and/or the accumulation of errors can be avoided.

Performing open-loop and/or closed loop control of the material feed may comprise perform open-loop and/or closed loop control of an amount of deposition material supplied to the machining area, a deposition material flow and/or an elevation of a material structure deposited in the machining area.

The deposition control device may be configured to control a power of the radiated laser beam (i.e. the laser power). The deposition control device may be configured to control the power of the radiated laser beam depending on or together with the material feed. The deposition control device may therefore be configured to control a power of the laser beam and/or to control the material feed and/or to control the feed device for performing open-loop and/or closed loop control of the material feed, in particular in order to perform open-loop and/or closed loop control of the amount of deposition material supplied to the machining area, the deposition material flow and/or the elevation of a material structure deposited in the machining area.

### BRIEF DESCRIPTION OF THE DRAWINGS

The invention is described in detail below with reference to figures.

FIG. 1 shows a schematic view of a device for laser deposition welding according to embodiments of the invention;

FIG. 2 shows a schematic view of a device for laser deposition welding according to embodiments of the invention;

FIG. 3 shows a schematic diagram of positions of a measuring beam on a first reflector;

FIG. 4 shows a schematic diagram of a measuring beam at different times of a scan figure of the measuring beam;

FIG. 5 schematically shows a scan figure of a measuring beam at a measuring position in advance and an elevation profile;

FIG. 6 shows schematically a scan figure of a measuring beam at a measuring position in the wake and an elevation profile;

FIG. 7 schematically shows a scan figure of a measuring beam at a measuring position in the machining point and an elevation profile; and

FIGS. 8, 9 and 10 each show a schematic view of a respective device for laser deposition welding according to embodiments of the invention.

### DETAILED DESCRIPTION OF THE INVENTION

In the following, unless otherwise stated, the same reference numbers are used for identical elements or elements with the same effect.

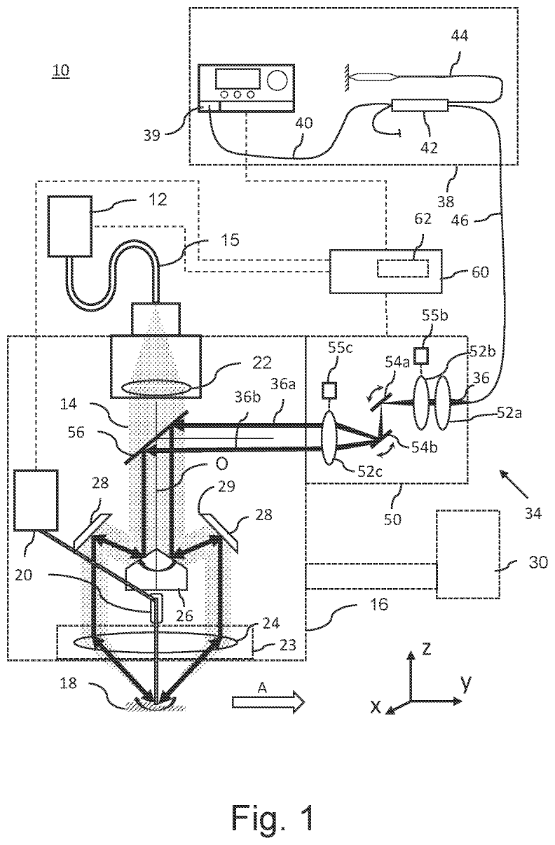

FIG. 1 shows a schematic diagram of a device 10 for laser deposition welding according to embodiments of the present disclosure. The device 10 may be coupled to a laser source 12 for generating a laser beam 14, also referred to as a machining laser beam, in order to couple the laser beam 14 into a laser machining head 16 of the device 10. The device 10 includes the laser machining head 16 for radiating and directing the laser beam 14 onto a machining area of a workpiece 18.

The device 10 further comprises a feed device 20 for a deposition material, which is configured to feed the deposition material to the machining area coaxially with the laser beam 14.

The device 10 may be configured to apply the fed deposition material to a workpiece 18 by laser deposition welding or to form at least one workpiece 18 from the supplied deposition material by laser deposition welding. The deposition material may be, for example, wire, a metal powder, or a powder-filled wire. In a plurality of machining passes, for example, structures may be formed from the deposition material on the workpiece 18. FIG. 1 schematically shows the configuration of a structure, for example a wall, the height of which protrudes in the already machined area of the workpiece 18 compared to the area still to be machined.

The laser beam 14 is transmitted from the laser source 12 to the laser machining head 16 via an optical fiber 15 and is coupled into the laser machining head 16 from one end of the optical fiber 15, for example by means of a fiber coupler. The laser machining head 16 may further comprise collimator optics 22 for collimating the laser beam 14 emerging divergently from the end of the optical fiber 15. With the aid of the collimator optics 22, the focus position of the laser beam 14 can be adjusted or corrected. The focus position may be adjustable, for example, along an optical axis of the laser machining head 16. The axis may be called the z-axis. The laser machining head 16 further includes a focusing device 23 with focusing optics 24 for focusing the laser beam 14 on the machining area. The focusing optics 24 may, for example, include a lens.

The laser machining head 16 further comprises a first reflector 26 and a second reflector 28, which are arranged concentrically on a common central axis which corresponds to the optical axis O of the laser machining head 16. The first reflector 26 is a conical metal reflector, the reflecting surface of which has continuous rotational symmetry with respect to the common central axis. The laser beam 14, which is incident on the first reflector 26 concentrically, is reflected outwards from the first reflector 26 onto the second reflector 28 at an angle with the central axis. The first reflector 26 thus splits the laser beam 14 and generates an annular beam profile of the laser beam 14.

The second reflector 28 is, for example, annular and reflects the laser beam 14 in a direction that is offset so as to be parallel to the central axis. The laser beam 14 reflected by the second reflector 28 may have an annular, for example cylindrical, beam profile. The laser beam 14 reflected by the second reflector 28 is then focused into the machining area by the focusing optics 24. The second reflector 28 thus reflects the laser beam 14 via the focusing optics 24 toward the machining area. The second reflector 28 is thus configured to reflect the laser beam 14 onto the machining area through the focusing optics 24 at an angle with the central axis. The second reflector has, for example, a reflecting surface with continuous rotational symmetry with respect to the common central axis. The second reflector 28 is annular and has a circular recess 29 which is concentric to the central axis. The reflective surface surrounds the circular recess 29. The second reflector is made of metal, for example. The laser beam 14, which is freely directed onto the machining area after passing through the focusing device 23, is directed into the machining area and/or onto the circumference of the coaxially fed deposition material by the focusing optics 24 so as to be annular and converging. The laser beam 14, which is freely directed onto the machining area, thus has an annular beam profile, the diameter of which decreases in the direction of the machining area. The deposition material is melted using the laser beam 14 and applied to the workpiece 18.

In order to apply the deposition material along a machining trajectory and to radiate the laser beam along the machining trajectory, the device 10 further comprises a positioning device 30 which can move the laser machining head 16 relative to the workpiece 18 in an x-direction, a y-direction and additionally in the z-direction. A current machining direction A is shown schematically in FIG. 1 and corresponds to a (current) feed direction of the laser machining head 16.

The device 10 further comprises a distance measuring device 34 for interferometric distance measurement or optical distance measurement by means of an optical measuring beam 36. The distance measuring device 34 is configured, for example, to measure a distance between the laser machining head 16 and the workpiece 18.

According to the embodiment, the distance measuring device 34 comprises an optical coherence tomograph or may be configured as an optical coherence tomograph. In other words, the distance measurement may be based on optical coherence tomography (OCT). The distance measuring device 34 includes an evaluation unit 38 with a broadband light source 39, for example a superluminescent diode. The light source 39 couples measuring light into an optical fiber 40. In a beam splitter 42, which is preferably configured as a fiber coupler, the measuring light is divided into a reference arm 44 and a measuring arm 46. The measuring light from the measuring arm 46 is transmitted as the optical measuring beam 36 via an optical fiber to a scanning device 50 for deflecting the measuring beam 36.

The scanning device 50 is a 2D scanning device for deflecting or displacing the optical measuring beam 36 relative to the laser beam 14 or relative to the optical axis O of the laser machining head 16. The scanning device 50 is configured to move and displace the optical measuring beam 36 along two directions with respect to the workpiece 18. The two directions may correspond to the x direction and y direction. The measuring beams 36a and 36b schematically represent the orientation of the measuring beam 36 at two different positions or at two different times. With the aid of the scanning device 50, the surface of the workpiece 18 can be scanned in a position relative to the machining position.

According to embodiments, the scanning device 50 includes two movable mirrors 54a, 54b, which can be rotated on different axes of rotation. The mirrors 54a, 54b may be configured as galvanometer mirrors. In this case, the scanning device 50 may be referred to as a galvanometer scanner or galvo scanner.

The scanning device 50 further comprises beam shaping optics 52 including at least one optical lens 52a, 52b, 52c for beam widening and/or collimation and/or focusing of the measuring beam 36. In particular, the beam shaping optics 52 may include a first lens 52a for collimating the measuring beam 36, a second lens 52b for focusing the measuring beam 36 on the scanning device 50, and a third lens 52c for re-collimating or widening the measuring beam 36.

The laser machining head 16 further comprises a coupling device 56 for coupling the optical measuring beam 36 into the laser machining head 16. The coupling device 56 is configured to superimpose the optical measuring beam 36 with the laser beam 14. The coupling device 56 comprises, for example, a beam splitter, which may be configured as or include a dichroic mirror. The beam splitter may reflect light from the optical measuring beam 36 and allow light from the machining laser beam 14 to pass through. According to embodiments, the (undeflected) optical measuring beam 36 and the laser beam 14 may extend in parallel and/or coaxial to one another at least in some sections. The coupling of the optical measuring beam 36 into the laser machining head 16 by the coupling device 56 takes place after the scanning device 50 in the beam propagation direction of the measuring beam 36 and takes place in front of the first reflector 26 and second reflector 28 in the subsequent common beam propagation orientation of the measuring beam 36 and the laser beam 14. In particular, the measuring beam 36 and the laser beam 14 pass the first reflector 26 and the second reflector 28 in a common beam path and are reflected together by the first reflector 26 and reflected together by the second reflector 28 toward the machining area and directed onto the machining area by the focusing optics 24.

Since the coupling device 56 is arranged after the scanning device 50 in the beam path of the measuring beam, the optical measuring beam 36 is deflected by the scanning device 50 relative to the laser beam 14.

The principle for distance measurement described here is based on the principle of optical coherence tomography, which uses the coherence properties of light with the aid of an interferometer. In order to measure the distance, the optical measuring beam 36 is radiated onto a surface of the workpiece 18. The portion of the optical measuring beam 36 reflected back from the surface is imaged onto the end of the optical fiber of the measuring arm 46 and superimposed and caused to interfere with the portion of the measuring light reflected back from the reference arm 44 in the beam splitter 42. The superimposed light contains information about the path length difference between the reference arm 44 and the measuring arm 46. This information is evaluated by the evaluation unit 38. This allows for information about the distance to the workpiece 18 or between the workpiece 18 and the laser machining head 16 to be obtained.

According to embodiments, the reference arm 44 may be configured as a dynamic reference arm. This allows for the measuring range of the measuring device 34 to be expanded.

The device 10 further comprises a control and evaluation device 60. The control and evaluation device 60 assumes the function of a control device for controlling the scanning device 50 so as to move the measuring beam 36 according to a scan path, in particular according to a predetermined scan figure. The scan figure defines, for example, a temporal profile of the scan path in the x-direction and y-direction. The scan figure may define a temporal profile of the scan path relative to the machining direction.

The control and evaluation device 60 includes a memory 62 for calibration data. The calibration data takes into account an optical distortion and an optical path length (or a reference elevation) of a beam path of the measuring beam 36 via the first reflector 26 and the second reflector 28. The control and evaluation device 60 may use the scanning device 50 to position or move the measuring beam 36 based on the stored calibration data.

The control and evaluation device 60 further assumes the function of an evaluation device for determining a surface geometry of the workpiece 18 based on the stored reference elevation data and from distances measured by the distance measuring device 34. The control and evaluation device 60 receives certain raw distance data, for example a distance, from the evaluation unit 38 for a current measuring position of the measuring beam 36 in accordance with the corresponding control of the scanning device 50. The control and evaluation device 60 may, for example, determine an actual distance to the workpiece 18 or an elevation of the workpiece 18 at the corresponding measuring position from the raw distance data determined by the evaluation unit 38 based on the reference elevation data. The control and evaluation device 60 may determine a surface geometry from the measured distances, for example generate an elevation profile along the scan path or the scan figure, based on the stored reference elevation data.

The control and evaluation device 60 further assumes the function of a deposition control device for performing open-loop and/or closed loop control of the material supply through the feed device 20. In particular, the control and evaluation device 60 is configured to control the material feed as a function of a distance measured by the distance measuring device 34 or of an actual distance determined based on the reference elevation data. For example, the material may be fed based on a measured distance or a measured elevation of the workpiece 18 along the machining direction in advance by a proportional-integral controller with a time offset in order to perform closed-loop control of the current material deposition at the corresponding point on the workpiece where the distance was measured.

In addition to the described deflection of the measuring beam 36 by means of the scanning device 50, the scanning device 50 may also be configured to adjust or modify an inclination of the measuring beam 36 with respect to the optical axis and/or a beam diameter of the measuring beam. For example, in the example of FIG. 1, the lenses 52b, 52c of the beam shaping optics may be adjustable in the direction of beam propagation in order to modify a beam diameter. For this purpose, the scanning device 50 may have respective actuating drives 55b, 55c for the lenses 52b, 52c, which are controlled by the control and evaluation device 60.

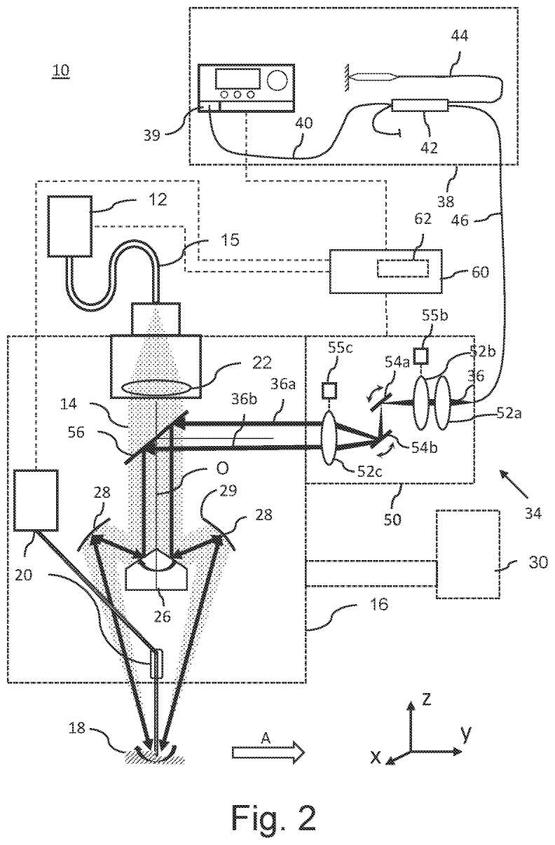

Further embodiments, which differ from the embodiments of FIG. 1 by a different structure of the second reflector 28, will be described below with reference to FIG. 2. Otherwise, the device 10 of FIG. 2 corresponds to the structure of the device 10 of FIG. 1.

In FIG. 2, the second reflector 28 is configured to reflect the laser beam 14 directly toward the machining area at an angle with the central axis. Furthermore, the second reflector 28 is configured to focus the laser beam with respect to the machining point, in particular to generate an annular focus. The second reflector 28 is, for example, a ring segment of a parabolic mirror and may, for example, focus both the laser beam and the measuring beam 36a, 36b. Instead of the focusing optics 24 of FIG. 1 formed by at least one lens, the laser beam 14 and the measuring beam 36a, 36b are thus focused by the curvature of the reflecting surface of the second reflector 28. The second reflector 28 reflects the laser beam 14 at an angle with the central axis in the direction of the machining area.

In the examples described, the feed material is fed to the machining area coaxially with the laser beam 14, with the supply of the feed material leading into the interior of the annular beam profile of the laser beam 14, as shown schematically in FIG. 1 and FIG. 2, through an area in which the laser beam 14 is radially divided so as to be annular. This minimizes shadowing of the laser beam 14 and the measuring beam 36. In this area, the feed device 20 may, for example, include a metallic protective cover for the feed material, which may be configured to be reflective.

In FIGS. 1 and 2, the coupling device 56 is configured to reflect light from the optical measuring beam 36a, 36b and to allow light from the laser beam 14 to pass through. However, the present disclosure is not limited thereto. The coupling device 56 may also be configured to allow light from the optical measuring beam 36a, 36b to pass through and to reflect light from the laser beam 14.

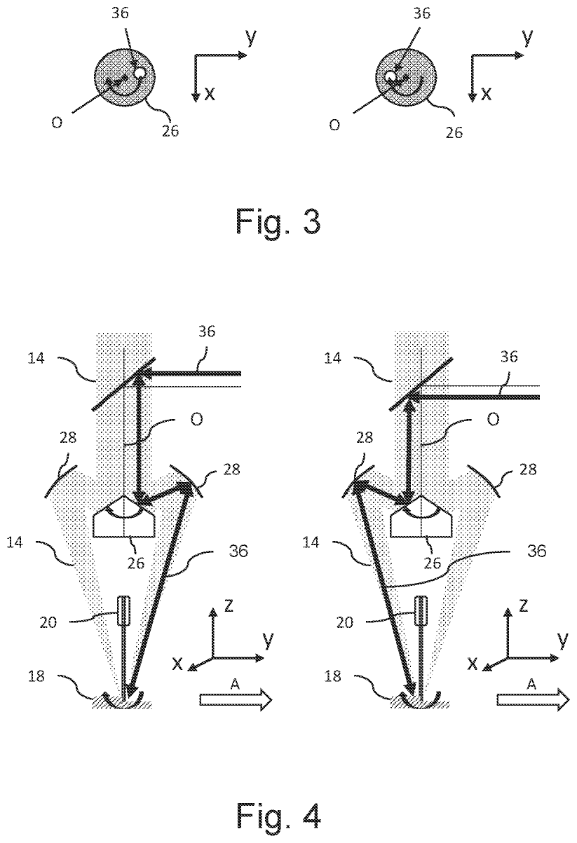

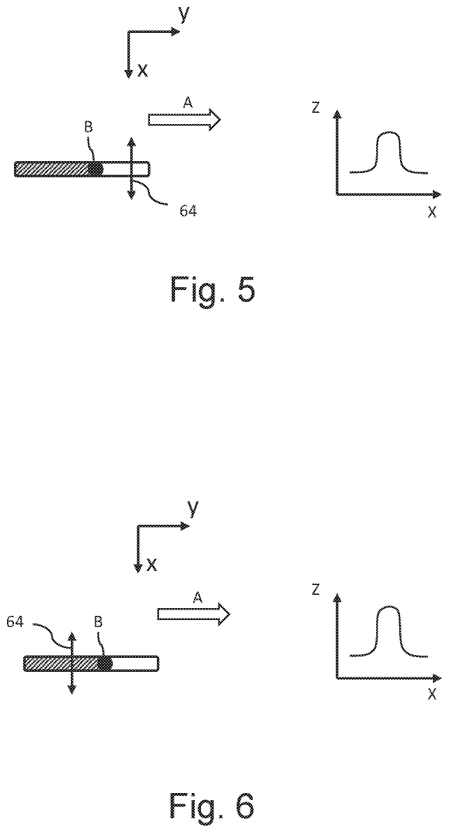

FIGS. 3 and 4 schematically show, by way of example, different deflections of the measuring beam 36 at different times of a scan FIG. 64 of the measuring beam 36. FIG. 3 schematically shows the respective position of the measuring beam 36 on the first reflector 26 in a plan view in the beam propagation direction of the laser beam 14. The scan FIG. 64 is, for example, circular and defines a circular revolution of the position of the measuring beam 36 around the optical axis O. In the left part of FIG. 3, the measuring beam 36 is located to the right of the optical axis O. The left part of FIG. 4 schematically shows the corresponding beam path of the measuring beam 36 and the laser beam 14 in the area between the coupling device 56 and the workpiece 18. The right part of FIG. 3 shows the measuring beam 36 at a position on the left side of the optical axis O. The right side of FIG. 4 accordingly shows the course of the optical measuring beam 36 and the course of the laser beam 14 in the area between the coupling device 56 and the workpiece 18. In the figures, arrows indicate the rotational movement of the measuring beam 36 about the optical axis O.

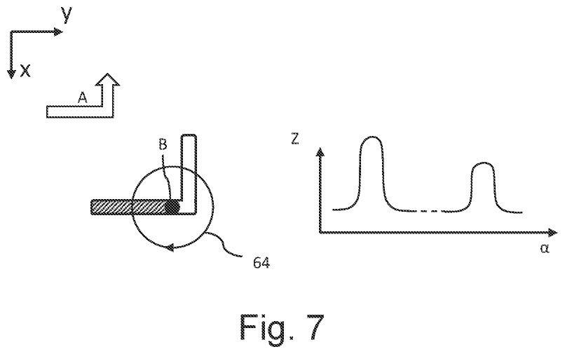

FIG. 5 schematically shows, by way of example, a distance measurement in advance with a line-shaped scan FIG. 64 transverse to the machining trajectory. For example, the profile curve of the elevation of the workpiece 18 shown schematically on the right in FIG. 5 is obtained along the scan FIG. 64. In the example, the scan FIG. 64 is arranged transversely to a deposited wall structure, the elevation of which may be determined from the elevation profile. In the current machining pass, a further layer is applied to the wall structure along the machining direction A. The material supply in the machining area B shown may be controlled at the current time based on the elevation previously measured for the same position of the workpiece, for example in order to achieve a target elevation of the structure to be deposited that is as uniform as possible.

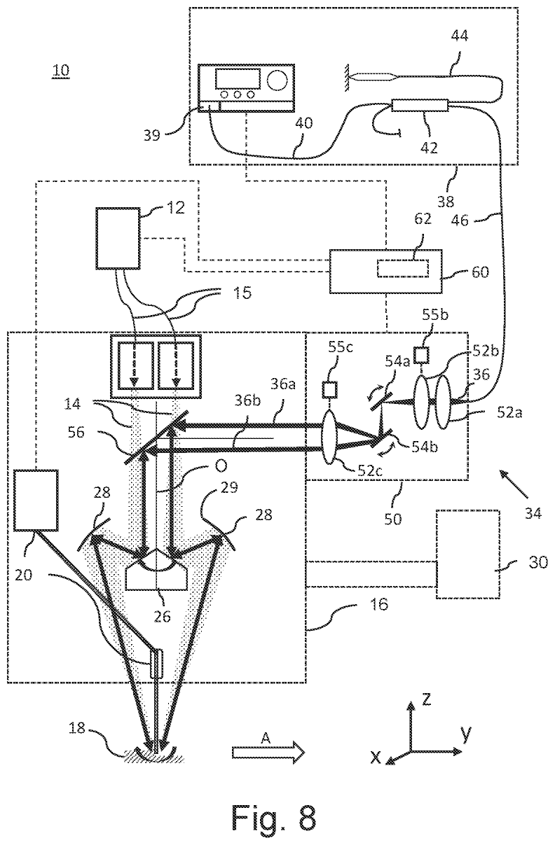

FIG. 6 schematically shows a measuring position in the wake. The elevation profile obtained here along the scan FIG. 64, shown on the right in FIG. 6, may be temporarily stored, for example, in a memory of the control and evaluation device 60 until the corresponding position on the workpiece 18 is reached again in a further machining pass. Here, the deposition quantity of the feed material may then be controlled accordingly, for example in order to obtain an overall deposition elevation of the deposition material along the structure to be deposited which is as uniform as possible.

In the examples of FIGS. 5 and 6, the control and evaluation device 60 positions the scan FIG. 64 based on the machining direction A and/or based on the machining trajectory and orients the scan FIG. 64 accordingly. In the example of the line-shaped scan FIG. 64 shown, the orientation is, for example, transverse to the machining trajectory. The control and evaluation device 60 accordingly controls the scanning device 50 for positioning and moving the measuring beam 36 based on the machining direction and/or the machining trajectory.

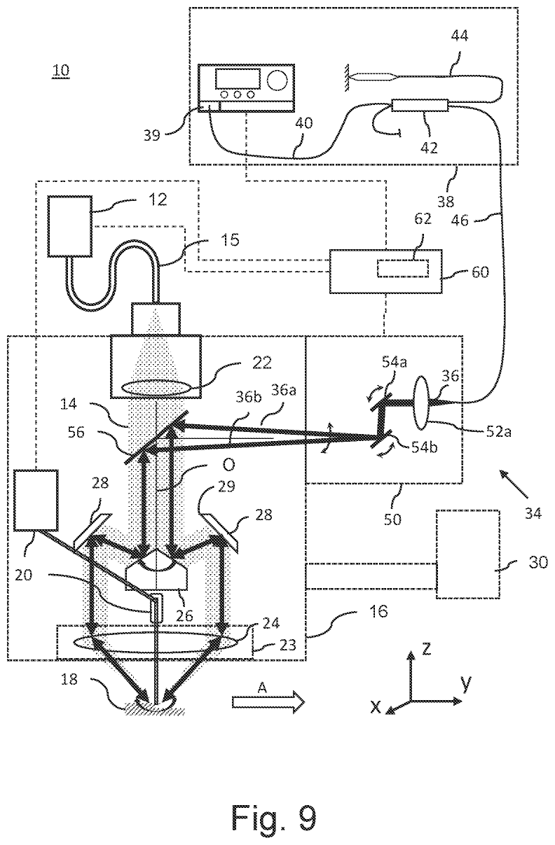

FIG. 7 shows an example of a circular scan FIG. 64 positioned around the machining point or the optical axis O. The example shows a deposited structure in which the machining path (the machining trajectory) includes segments of different directions. The right part of FIG. 7 shows the elevation profile obtained along the scan FIG. 64 in the elevation direction z above the circumferential angle of the scan FIG. 64. Taking into account the course of the machining trajectory, the distance may be measured along the machining trajectory both in advance and in the wake. The control and evaluation device 60 may perform closed-loop control of the material feed through the feed device 20 as a function of the determined elevation or the measured distance on the machining trajectory (in advance), for example to achieve a uniform material deposition elevation along the machining trajectory.

In addition to the described control of the feed device 20, the control and evaluation device for controlling the material deposition elevation may, for example, also control the laser source 12 in order to control an intensity of the laser beam.

While FIGS. 5 and 6 show distance measurements at measuring positions in advance or in the wake and FIG. 7 shows distance measurements at measuring positions at a distance from the machining area, the control and evaluation device 60 may also be configured to carry out a distance measurement at a measuring position in the machining area, for example near the optical axis O, and use it, for example, to perform closed-loop control of the material feed.

In the embodiments of FIGS. 1 and 2, instead of the conical first reflector 26 described, a pyramid-shaped first reflector 26 with a rotationally symmetrical arrangement of reflecting surfaces (facets) may also be used, for example, in order to split the laser beam 14 and reflect it outwards onto the second reflector. The second reflector 28 may then consist of, for example, annularly arranged segments. In particular, the first and/or the second reflector may have a discrete rotational symmetry of reflecting surface(s) thereof.

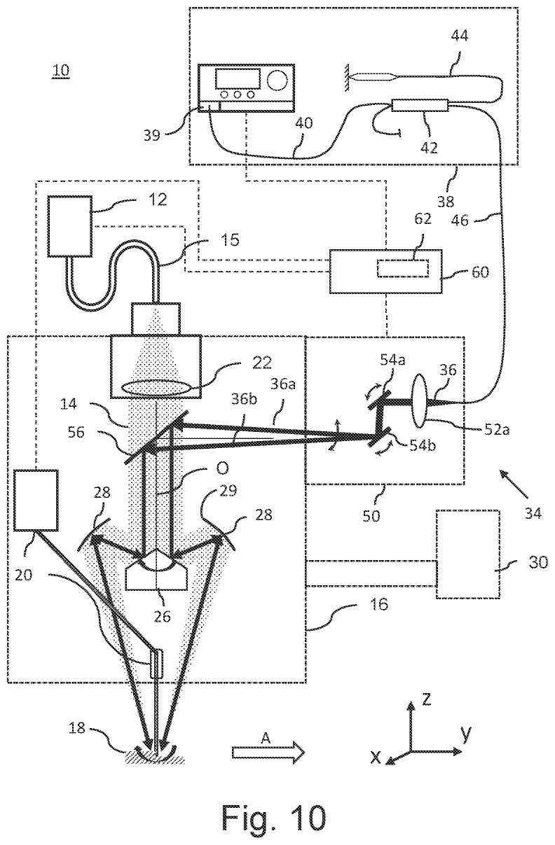

FIG. 8 shows another example of a device 10 for laser deposition welding according to embodiments of the invention. The device 10 shown in FIG. 8 differs from the device shown in FIG. 2 in that the laser beam 14 is fed from the laser source 12 to the laser machining head 16 via a fiber array of optical fibers 15. The laser beam 14 thus comprises a plurality of (partial) laser beams, which are deflected by the first reflector 26 to a radial distribution of beams and reflected onto the second reflector 28. The laser beam 14 may, for example, have an annular beam profile as it passes through the coupling device 56 and is incident on the first reflector 26. The annular beam profile of the laser beam 14 is expanded by the first reflector 26 and the second reflector 28 and guided around the coaxial material feed.

A further embodiment of the device 10 is shown in FIG. 9. This embodiment differs from the embodiment in FIG. 1 only in that the measuring beam 36 is only collimated and, accordingly, the beam shaping optics 52 of the scanning device 50 only includes a lens 52a for collimation. By means of the scanning device 50, the collimated measuring beam 36 is deflected such that it does not extend completely in parallel to the optical axis O. As a result, the measuring beam 36 may also hit the workpiece somewhat offset from the laser beam 14. This embodiment has the advantage of a compact and simple structure.

A further embodiment of the device 10 is shown in FIG. 10. This embodiment differs from the embodiment in FIG. 2 only in that the measuring beam 36 is collimated analogously to FIG. 9, and, accordingly, the beam shaping optics 52 of the scanning device 50 only comprises a lens 52a for collimation. By means of the scanning device 50, the collimated measuring beam 36 is deflected such that it does not extend completely in parallel to the optical axis O. As a result, the measuring beam 36 may also hit the workpiece somewhat offset from the laser beam 14. This embodiment also has the advantage of a compact and simple structure.

A preferred aspect of the invention and specific embodiments thereof are presented below:

1. A device for laser deposition welding according to this aspect comprises: a laser machining head for radiating a laser beam; a feed device for coaxially feeding a deposition material; and a first reflector and a second reflector having a common central axis, wherein the first reflector is configured to reflect the laser beam outwardly onto the second reflector at an angle with the central axis, and wherein the second reflector is configured to reflect the laser beam toward the machining area.

2. The device according to number 1, wherein the first and second reflectors are arranged in front of the feed device in the beam propagation direction of the laser beam.

3. The device according to number 1 or 2, wherein the second reflector is configured to reflect the laser beam offset in parallel to the central axis or at an angle with the central axis toward the machining area.

4. The device according to number 1, 2 or 3, wherein the second reflector is configured to focus the laser beam and/or the measuring beam with respect to a machining point.

5. The device according to number 1, 2, 3 or 4, further comprising: a deposition control device for performing open-loop and/or closed loop control of the material feed and/or a laser power.

6. The device according to one of numbers 1 to 5, wherein the deposition material is a deposition material in the form of a wire, a powder-filled wire or a powder.

7. The device according to one of numbers 1 to 6, wherein the first reflector is substantially conical and/or pyramid-shaped.

8. The device according to one of numbers 1 to 7, wherein the first reflector has at least one reflecting surface with continuous or discrete rotational symmetry with respect to the common central axis.

9. The device according to one of numbers 1 to 8, wherein the second reflector has at least one reflecting surface with continuous or discrete rotational symmetry with respect to the common central axis.

10. The device according to one of numbers 1 to 9, wherein the second reflector is annular and/or has a circular recess which is concentric with the central axis and surrounds a reflective surface.

11. The device according to one of numbers 1 to 10, wherein the second reflector is a ring segment of a parabolic mirror.

12. The device according to one of numbers 1 to 11, wherein the first reflector and/or the second reflector is made of metal.

13. The device according to one of numbers 1 to 12, wherein the laser beam is annular after emerging from the laser machining head.

14. The device according to one of numbers 1 to 13, further comprising: a distance measuring device for measuring a distance by means of a measuring beam; and a scanning device for deflecting the measuring beam.

15. The device according to number 14, further comprising: a coupling device for coupling the beam path of the measuring beam into the beam path of the laser beam.

16 The device according to number 15, wherein the first reflector and the second reflector are arranged between the coupling device and the feed device and are located in a common beam path of the laser beam and the measuring beam.

17. The device according to number 14, 15, or 16, further comprising: a control device for controlling the scanning device, wherein the control device is configured to control the scanning device for positioning or moving the measuring beam.

18. The device according to number 14, 15, 16 or 17, wherein the device comprises a memory for calibration data, said calibration data taking into account an optical distortion and/or an optical path length of a beam path of the measuring beam, in particular an optical path length of a beam path of the measuring beam via the first reflector and/or via the second reflector and/or via further optical components.

19. The device according to number 18, wherein the control device is configured to control the scanning device for positioning or moving the measuring beam based on data from an XY calibration stored in the memory.

20. The device according to number 18 or 19, wherein the distance measuring device is configured to determine a relative elevation at a respective measuring position based on the reference elevation data stored in the memory and the measured distances.

21. The device according to number 14, 15, 16, 17, 18, 19 or 20, wherein the distance measuring device is configured to measure the distance at a measuring position in advance, in the machining area and/or in the wake.

22. The device according to number 14, 15, 16, 17, 18, 19, 20 or 21, wherein the distance measuring device comprises an optical coherence tomography (OCT) device or a time-of-flight (ToF) sensor.

23. The device according to number 14, 15, 16, 17, 18, 19, 20, 21 or 22, further comprising an evaluation device for determining a surface geometry from distances measured by the distance measuring device.

23. The device according to one of numbers 1 to 22, further comprising focusing optics arranged on the common central axis in order to focus the laser beam.

24. The device according to number 23, wherein the second reflector is configured to reflect the laser beam onto the machining area through the focusing optics at an angle with the central axis.

25. The device according to number 14, 15, 16, 17, 18, 19, 20, 21 or 22, further comprising focusing optics arranged on the common central axis in order to focus the laser beam and/or the measuring beam.

26. The device according to number 25, wherein the second reflector is configured to reflect the laser beam and/or the measuring beam through the focusing optics at an angle with the central axis onto the machining area.

27. The device according to number 14, 15, 16, 17, 18, 19, 20, 21, 22, 25 or 26, further comprising a deposition control device for performing open-loop and/or closed loop control of a laser power and/or the material feed through the feed device as a function of a distance measured by the distance measuring device and/or of a surface geometry determined from distances measured by the distance measuring device.

### LIST OF REFERENCE SYMBOLS

10 device for laser deposition welding
12 laser source
14 laser beam
15 optical fiber
16 laser machining head
18 workpiece
20 feed device
22 collimator optics
23 focusing device
24 focusing optics
26 first reflector
28 second reflector
29 recess
30 positioning device
34 distance measuring device
36 measuring beam
38 evaluation unit
39 light source
40 optical fiber
42 beam splitter
44 reference arm
46 measuring arm
50 scanning device
52 beam shaping optics
52a, 52b, 52c lenses
52c collimation lens
54a. 54b mirror
55b, 55c actuating drives
56 coupling device
60 control and evaluation device
62 memory
64 scan FIG.
70 scanning device
72a, 72b scanning mirror

1. A device for laser deposition welding, comprising:
a laser machining head for radiating a laser beam;
a distance measuring device for measuring a distance using a measuring beam;
a scanning device for deflecting said measuring beam;
a coupling device for coupling the beam path of said measuring beam into the beam path of said laser beam;
a feed device for coaxially feeding a deposition material; and
a first reflector and a second reflector, which have a common central axis and which are arranged between said coupling device and said feed device in a common beam path of said laser beam and said measuring beam,
wherein said first reflector is configured to reflect said laser beam and said measuring beam outwards onto said second reflector at an angle with the central axis, and
wherein said second reflector is configured to reflect said laser beam toward a machining area.

2. The device according to claim 1, wherein said second reflector is configured to reflect said laser beam offset in parallel to the central axis or at an angle with the central axis toward the machining area.

3. The device according to claim 1, wherein said second reflector is configured to focus said laser beam and/or said measuring beam with respect to a machining point.

4. The device according to claim 1, further comprising:
a control device for controlling said scanning device, wherein said control device is configured to control said scanning device for positioning or moving said measuring beam based on a machining direction and/or a machining trajectory.

5. The device according to claim 4, wherein said control device is configured to control said scanning device for moving said measuring beam according to a predetermined scan figure, wherein said control device is configured to position and/or orient said scan figure based on a machining direction and/or a machining trajectory.

6. The device according to claim 4, wherein said device comprises a memory for calibration data taking into account an optical distortion and/or an optical path length of a beam path of said measuring beam via said first reflector and/or or via said second reflector and/or via further optical components, and wherein:
said control device is configured to control said scanning device for positioning or moving said measuring beam based on the reference elevation data stored in said memory; and/or
said distance measuring device is configured to determine a relative elevation at a respective measuring position based on the reference elevation data stored in said memory and the measured distances.

7. The device according to claim 1, wherein said distance measuring device is configured to measure the distance at a measuring position in advance, in the machining area and/or in the wake.

8. The device according to claim 1, further comprising:
an evaluation device for determining a surface geometry from distances measured by said distance measuring device.

9. The device according to claim 1, wherein said distance measuring device comprises an optical coherence tomography device or a time-of-flight (ToF) sensor.

10. The device according to claim 1, wherein the deposition material is a deposition material in the form of a wire, a powder-filled wire or a powder.

11. The device according to claim 1, wherein said first reflector is substantially conical and/or pyramid-shaped, and/or
wherein said first reflector has at least one reflecting surface with continuous or discrete rotational symmetry with respect to the common central axis.

12. The device according to claim 1, wherein said second reflector has at least one reflecting surface with continuous or discrete rotational symmetry with respect to the common central axis.

13. The device according to claim 1, wherein said second reflector is annular and/or has a circular recess which is concentric to the central axis and surrounds a reflective surface, and/or wherein said second reflector is a ring segment of a parabolic mirror.

14. The device according to claim 1, wherein said first reflector and/or said second reflector is made of metal.

15. The device according to claim 1, wherein said device further comprises focusing optics arranged on the common central axis in order to focus said laser beam and/or said measuring beam, and
wherein said second reflector is configured to reflect said laser beam and/or said measuring beam onto the machining area through said focusing optics at an angle with the central axis.

16. The device according to claim 1, wherein said laser beam is annular after emerging from said laser machining head.

17. The device according to claim 1, further comprising:
a deposition control device for performing open-loop and/or closed loop control of the material feed through said feed device and/or a laser power as a function of a distance measured by said distance measuring device and/or of a surface geometry determined from distances measured by said distance measuring device.
